(19) United States
(12) Patent Application Publication
(10) Pub. No.: US 2004/0083429 A1
(43) Pub. Date: Apr. 29, 2004

(54) Document browser, document browsing method, and recording medium in which a program is recorded for executing document browsing method on computer

(75) Inventor: Katsuhiko Akiyama, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/687,617

(22) Filed: Oct. 20, 2003

(30) Foreign Application Priority Data
Oct. 21, 2002 (JP) 2002-305458

(51) Int. Cl. G06F 17/00

(52) U.S. Cl. 715/513; 715/541

(57) ABSTRACT

A document browser is disclosed that makes it possible to receive additional information such as a handwritten mark, and to merge and display this with document data, and makes it possible to search and re-view document data based on the additional information. The document browser includes: an additional information receiving means for receiving input of additional information; a browsing means for merging and displaying on a display device document data with the additional information; a positional information obtaining means for obtaining information of a position of the additional information in the document data; a properties information obtaining means for obtaining properties information of the additional information; an additional information storage means for storing the additional information with the positional information and the properties information; an additional information searching means for searching the additional information stored in the additional information storage means based on the properties information of the additional information; and a search results display means for displaying on the display device the search results found by the additional information searching means.

### BACKGROUND OF THE INVENTION

1. Field of the Invention

The present invention relates to document browsers, document browsing methods, and recording medium in which a program is recorded for executing a document browsing method on a computer that receive input of additional information about document data that includes data that can be displayed on a display device such as text data and image data, and are capable of merging and displaying the document data and the additional data.

2. Description of the Related Art

There are many software applications that display document data including data such as text data and image data on display devices such as CRTs and liquid crystal displays.

For example, structured documents such as HTML documents and XML documents that reside on the WWW (World Wide Web) accessible via the Internet can be displayed on display devices using a web browser such as the Microsoft Internet Explorer.

With a web browser such as this, it is possible to include link information constituted by address information of the storage location of informational content associated with an object such as a character string in text data and image data displayed in the document data. When an object provided with link information in this way is specified, it is possible for an address such as a URL (uniform resource locator) contained in that link information to be accessed, and the associated informational content to be obtained and displayed on a display device.

In addition to such hyperlink functionality, document browsers have been proposed (see JP 2002-149679A) that are capable of extracting the link objects and link information residing in document data, and displaying a list of the link objects from which the informational content associated with the list display can be accessed.

When continually using a document browser, it frequently occurs that a user will look at the same information many times, or want to see again information that has been seen before. This is why web browsers have lists of link information such as those called “Favorites” and “Bookmarks,” and the lists of link information can be customized by users specifically adding link information to the list. Consequently, with such web browsers, it is possible for a user to view informational content by selecting the desired information from a list of link information without inputting address information such as a URL.

When there is important information or attention-worthy portions of text or images presented in books, magazines, or other paper-based media, it is common to directly write in an underline or some other marking by using a pencil, a ball pen, or a line marker or the like.

Devices have been proposed with which, like these paper-based media, additional information that has been input to the electronic document data by handwriting can be received, merged with the document data, and displayed (see JP S60-173620A and JP2001-195045A).

In JP S60-173620A, a display device has been proposed in which the track movements of a write pen on a display screen are detected, merged with the document data, and displayed.

Furthermore, in JP 2001-195045A, a device has been proposed with which it is possible, with a plurality of other computers connected by cabling, to merge the track image that is input on one of those computers by a pointer such as a mouse with the images on the other computers and display merged images.

When displaying a list of links with a method such as that described in JP2000-149679A, or a method such as “Bookmarks,” it becomes difficult to find the desired link in the list when the number of links becomes too large. For this reason, it is necessary for the user to select links carefully and make efforts in deciding which to leave in the list. However, it is not always easy to judge at that time which information will be required later, and it may become difficult to once again view that information afterwards because links were not kept in the list.

Furthermore, in JP S60-173620A and JP2001-195045A, although the additional information handwritten by the user is received and that track information is merged with ordinary document data and displayed, positional information concerning which position the additional information is arranged in the document data, and properties data such as that of the special characteristics or classification of the additional data is not accumulated with the additional data, so it is difficult to search the additional data in the conditions under which it is associated with the document data, and there is the problem that the document data cannot be viewed again under the same conditions in which the additional information is attached.

It is an object of the present invention to offer a document browser that makes it possible to receive additional information such as handwritten markings, and to merge and display this with document data, and to make it possible to search and view again document data based on the additional information.

### BRIEF SUMMARY OF THE INVENTION

The document browser of the present invention merges and displays additional information with document data, including text data and/or image data, that can be displayed on a display device, and is provided with: an additional information receiving means for receiving input of the additional information; a browsing means for merging and displaying on the display device the document data with the additional information; a positional information obtaining means for obtaining information of a position of the additional information in the document data; a properties information obtaining means for obtaining properties information of the additional information; an additional information storage means for storing the additional information with the positional information and the properties information; an additional information searching means for searching the additional information stored in the additional information storage means based on the properties information of the additional information; and a search results display means for displaying on the display device the search results found by the additional information searching means.

Here, document data may refer to an HTML document, an XML document, or other structured document.

Furthermore, properties information may refer to attribute information included in the additional information such as line color, level of transparency, and line thickness; or other properties data of the additional information such as a shape classification, size, or date and time of input.

Further still, additional information receiving means may refer to a pen tablet, a mouse, or other pointing device.

Furthermore, the additional information can be displayed semi-transparently so that the document data is identifiable when the additional information is merged with the document data.

The document browsing method of the present invention is, a document browsing method in which additional information is merged and displayed with document data, including text data and/or image data, that can be displayed on a display device, and is provided with: a step of displaying the document data on a display device; a step of receiving an input of additional information with respect to the document data displayed on the display device; a step of merging and displaying on the display device the document data with the additional information; a step of obtaining information of a position of the additional information in the document data; a step of obtaining properties information of the additional information; a step of storing the additional information with the positional information and the properties information; a step of searching the additional information stored in the additional information storage means based on the properties information of the additional information; and a step of displaying on the display device the search results found by the additional information searching means.

The recording medium of the present invention is a recording medium in which a program for executing a document browsing method is recorded, in which additional information is merged and displayed with document data, including text data and/or image data, that can be displayed on a display device. The program executes a step of displaying the document data on a display device; a step of receiving the additional information input to the document data displayed on the display device; a step of merging and displaying on the display device the document data with the additional information; a step of obtaining the positional information of the additional information in the document data; a step of obtaining properties information of the additional information; a step of storing the additional information with the positional information and the properties information; a step of searching the additional information stored in the additional information storage means based on the properties information of the additional information; and a step of displaying on the display device the search results found by the additional information searching means.

### BRIEF DESCRIPTION OF THE DRAWINGS

FIG. 1 is a block diagram of the control of a document browser employing a first embodiment of the present invention.

FIG. 2 is a flowchart of that control.

FIG. 3 is a flowchart of that control.

FIG. 4 is a flowchart of that control.

FIG. 5 is a flowchart of that control.

FIG. 6 is a diagram of a tablet with integrated display.

FIG. 7 is a diagram showing an example of a display screen.

### DETAILED DESCRIPTION OF THE PREFERRED EMBODIMENTS

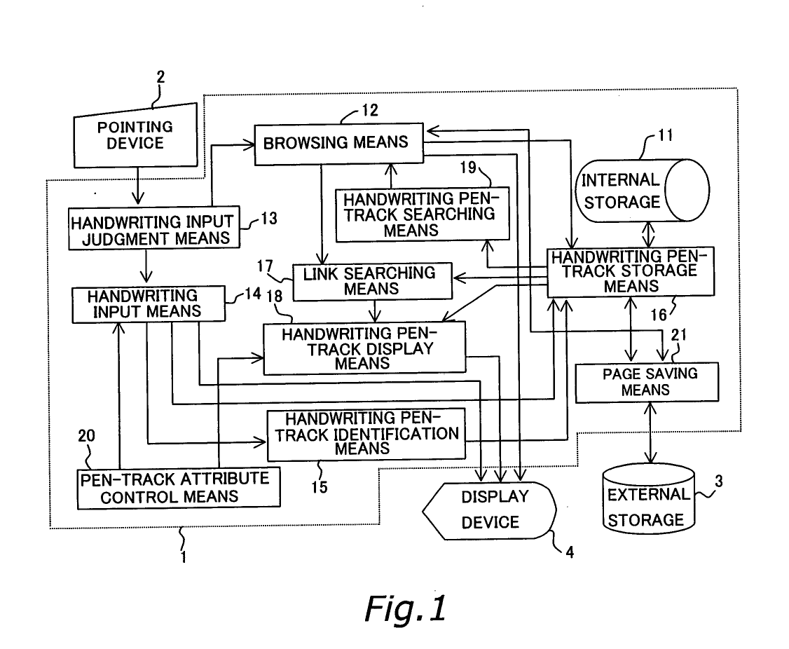

The document browser of the present invention is realized as application software that is installed on mobile computers such as PDAs (personal data assistants) and general computers such as ordinary personal computers and workstations. As shown in FIG. 1, application software is deployed on an internal storage means 11 of a computer unit 1, which contains a CPU, a ROM, a RAM, and various interfaces, and is structured with portions for each function.

The computer unit 1 is connected to: a pointing device 2 constituted by a keyboard, a mouse, a tracker ball, a touch pad, an input tablet, or other input means; a display device 4 constituted by a liquid crystal display, a CRT, or similar; and an external storage means 3 constituted by an HDD (hard-disk drive) or other storage means.

Inside the computer unit 1, functional portions are arranged, such as a browsing means 12, a handwriting input judgment means 13, a handwriting input means 14, a handwriting pen-track identification means 15, a handwriting pen-track storage means 16, a link searching means 17, a handwriting pen-track display means 18, a handwriting pen-track searching means 19, a pen-track attribute control means 20, and a page saving means 21.

The browsing means 12 offers ordinary basic document-browsing functionality. It is provided with functionality equivalent to the web document viewing functionality such as that of Microsoft's Internet Explorer (registered trademark), and Netscape's Netscape Navigator (registered trademark), and the PDF document viewing functionality such as that of Adobe's Acrobat Reader (registered trademark).

The handwriting input judgment means 13 judges whether or not a point indicated on a screen by the pointing device 2 is a possible area for handwriting input. For example, when there is an indication by the pointing device 2 on a hypertext link object displayed in the web browser, the informational content linked to that link is displayed, but if handwriting input is enabled on the link object, there is a risk that the hyperlink will not function properly. Therefore, when the position currently indicated by the pointing device 2 in the document data being displayed by the browsing means 12 is a screen element that holds a special function, the positional information indicated by the pointing device 2 is sent as it is to the browsing means 12, but when this is not the case, the positional information indicated by the pointing device 2 is sent to the handwriting input means 14.

Based on the positional information indicated by the pointing device 2, the handwriting input means 14 generates pen-track data for those tracks, and stores the data to the internal storage means 11 via the handwriting pen-track storage means 16.

The handwriting pen-track identification means 15 uses pattern recognition technology to identify what kind of shape classification there is for the pen-track data that has been input using the pointing device 2. For example, when the correlation coefficient of each point that makes up the pen-track data is obtained, and the pen-track is sufficiently straight in comparison to predetermined standard values, and the slant of that straight line is horizontal, and is positioned directly under a character string in the document data displayed by the browsing means 12, then the pen-track can be identified as an underline. Patterns of other shapes including data enclosures such as circles, triangles, rectangles, and other closed curves, and checkmarks can also be classified by shape classification. Pattern recognition technology that judges which shape a pattern best matches has long been known, and detailed description of that technology will be omitted here. The shape classification identified by the handwriting pen-track identification means 15 is associated with the pen-track data generated by the handwriting input means 14, and stored to the internal storage means 11 via the handwriting pen-track storage means 16. The handwriting pen-track identification means 15 is configured so that classification is carried out according to the size of the pen-track data that is input. For example, the size of pen-track data can be classified by obtaining the surface area of a rectangle that internally includes the input pen-track data, and judging whether or not this surface area belongs to a preset range.

The pen-track data (coordinate information input by the pointing device 2 and attribute information input from the pen-track attribute control means 20) obtained from the handwriting input means 14, the shape classification of the pen-track data obtained from the handwriting pen-track identification means 15, the size classification, the URL of the document data that the browsing means 12 is displaying at that time, as well as the positional information of the pen-track data in that document data, and the date and time of input, etc. are associated by the handwriting pen-track storage means 16 with the pen-track data and stored in the internal storage means 11.

The link searching means 17 operates with the timing of when the contents of the web page being displayed by the browsing means 12 change, and a search is made to see whether or not the URL of the displayed page is among the URLs recorded by the handwriting pen-track storage means 16. When there is a URL among the URL stored in the internal storage means 11 by the handwriting pen-track storage means 16 that matches the URL of the page being displayed, that URL and its associated pen-track data are read out from the internal storage means 11, merged with the web page through the handwriting pen-track display means 18, and displayed.

The handwriting pen-track display means 18 displays the pen-track data that is stored in the internal storage means 11 by the handwriting pen-track storage means 16 in such a way that it is displayed on the screen of the display device 4 in the predetermined position on the associated web page.

The handwriting pen-track searching means 19 searches in the pen-track data that is stored in the internal storage means 11 by the handwriting pen-track storage means 16 for pen-track data of a shape classification specified by the user. When there is pen-track data that matches a shape classification residing in the internal storage means 11, the pen-track data is presented to the user as search results. A web page associated with the pen-track data that the user selects from a displayed list is displayed with the pen-track data via the browsing means 12. At this time, because the browsing means 12 retrieves the pen-track data via the link searching means 17, the web page and the pen-track data associated with it are merged and displayed on the display device 4.

The pen-track attribute control means 20 receives from the user attribute information related to display attributes such as the color, level of transparency, and thickness of the line(s) that make up the pen-track data, and updates the attribute information in response to the received indications. The instructions from the user about attribute information can be received by a variety of methods, for example, by displaying a menu for selecting on-screen color, level of transparency, line thickness, and so on, and receiving the input instructions for attribute information in response to user operations. Furthermore, when receiving input of pen-track data from a pen tablet, this may be configured by preparing different pens according to color, level of transparency, and line thickness, and obtaining the attribute information by identifying the pen that is used.

The page saving means 21 associates the contents of the web page with the pen-track data stored in the internal storage means 11 by the handwriting pen-track storage means 16 and the information accompanying that, and stores this in the external storage means 3. In most cases a web page is administered by a site administrator who is different from the web browser user who views the page remotely, and it is possible for a web page with a certain URL to be altered or deleted regardless of the intentions of the web browser user, thus there may be occasions when the stored pen-track data and the web page are not in accordance with each other. For this reason, a configuration is possible in which, when pen-track data has been input, the contents of the associated web page are stored in the external storage means 3, thus always maintaining the relationship between the pen-track data and the contents of the web page. As the amount of data in the external storage means 3 would become massive if all the contents of web pages to which pen-track data had been added were to be stored, a configuration is possible in which the user may select the web pages to be saved. For example, a configuration is possible in which only web pages that have been written on with pen-track data of a predetermined shape classification are saved in the external storage means 3, and for web pages that have been written on with pen-track data of other shape classifications, only the pen-track data and its accompanying information are saved in the external storage means 3.

In an environment in which the screen displayed by the browsing means 12 is displayed as a window, the layout of the web page may sometimes be changed by the window size being altered by a user operation. At these times, a configuration is possible in which the display size of the web page on which pen-track data has been written can be saved in the external storage means 3 together with the pen-track data, and the web page can be displayed with the saved display size when redisplaying the web page including the pen-track data, thus making it possible to maintain the same positional relationship between the web page and the pen-track data as at the time of input. Furthermore, methods are also possible in which not the positional relationship between the entire web page and the pen-track data, but the positional relationship between structural elements within the web page, such as a paragraph within text data or image data for example, and the pen-track data are saved, and the display position of the pen-track data is altered in accordance with positional changes of structural elements accompanying display size changes.

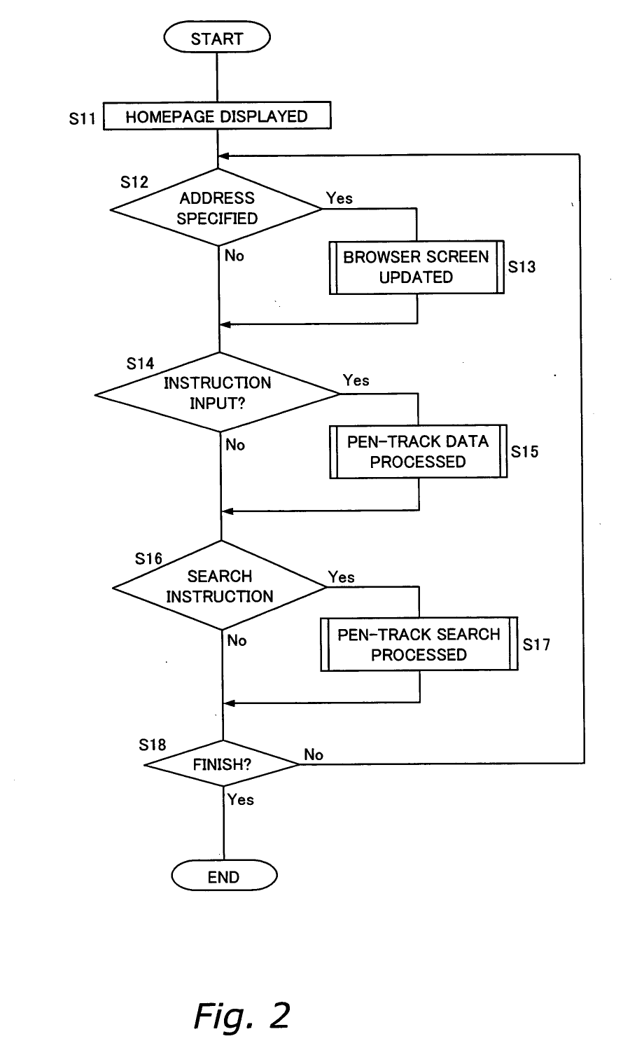

The following is a description of the operation of the thus-configured document browser based on the control flowchart shown in FIG. 2.

When the application starts, the browsing means 12 accesses a web page that is preset as the homepage, obtains the contents, and displays this on the display device 4.

In step S12, it is judged whether or not the address of a web page other than the web page currently being displayed on the display device 4 is specified. When a URL of a web page is input here as an address, or when a link object residing on the web page currently being displayed is clicked, it is judged that an address of a web page has been input, and the procedure advances to step S13.

In step S13, the contents of the corresponding web page based on the address that has been input are obtained, and the browser screen that displays the contents on the display device 4 is updated.

In step S14, it is judged whether or not an instruction has been input from the pointing device 2. When it is judged that an instruction has been input from the pointing device 2, the procedure advances to step S15.

In step S15, pen-track data processing is executed in which pen-track data that has been input from the pointing device 2 is obtained.

In step S16, it is judged whether or not there is a search instruction related to pen-track data. For example, when a pen-track data search menu is displayed on the display device 4, and a pen-track data search is specified from this menu, it is judged that a search instruction related to pen-track data has been made, and the procedure advances to step S17.

In step S17, pen-track search processing is executed in which pen-track data is searched based on a specified search item.

In step S18, it is judged whether or not there is an instruction to finish this process. When an instruction to finish that has been input from the user is received, the application is finished.

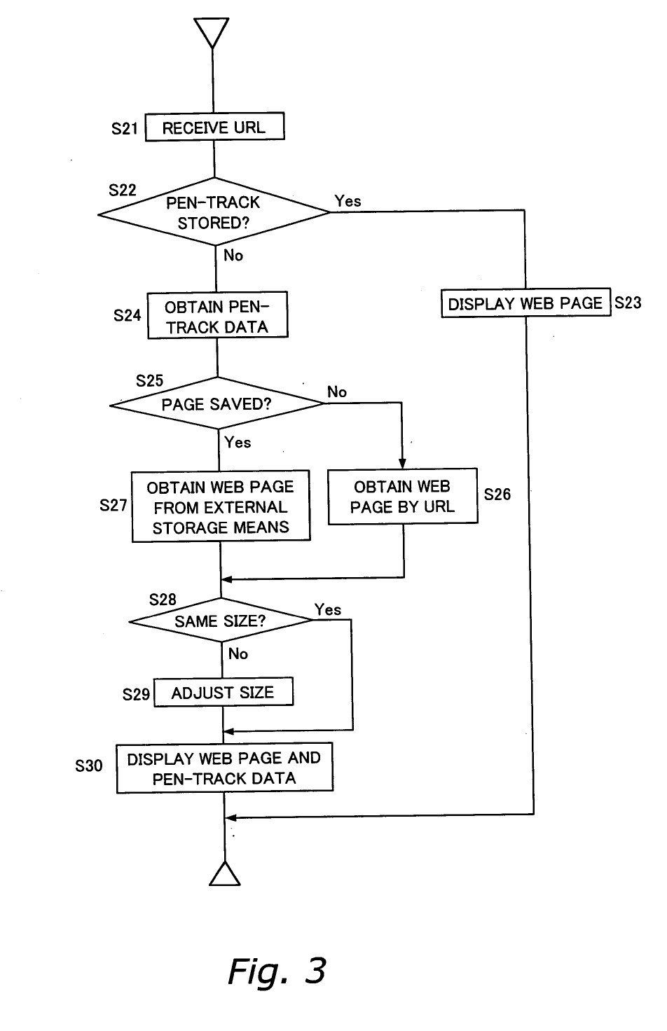

The following is a more detailed description of the process in which the browser screen is updated in step S13 shown in FIG. 2 based on the flowchart in FIG. 3.

In step S21, the instructed address is received. Here the URL input from the user, or the URL that is set to a link object that has been specified by the user, is obtained.

In step S22, it is judged whether or not the obtained URL matches a URL that is stored by the handwriting pen-track storage means 16. The URLs stored by the handwriting pen-track storage means 16 are searched by the link searching means 17, and when it is judged that there is a matching URL among these URLs, the procedure advances to step S24, or if there is no match, the procedure advances to step S23.

In step 23, the specified URL is accessed to obtain the informational content of the applicable web page, which is then displayed on the display device 4 via the browsing means 12.

In step 24, the pen-track data stored by the handwriting pen-track storage means 16 is obtained. The corresponding pen-track data is obtained here by retrieving the pen-track data associated with the specified URL, either from the pen-track data held in the internal storage means 11, or from the pen-track data stored in the external storage means 3.

In step 25, it is judged whether or not the informational content of the web page corresponding to the specified URL has been stored in the external storage means 3 by the page saving means 21. When it is judged that the informational content of the web page corresponding to the specified URL is stored in the external storage means 3, the procedure advances to step S27, or if it is not stored, the procedure advances to step S26.

In step S26, the web page corresponding to the specified URL is accessed and the corresponding informational contents are obtained.

In step S27, the informational content of the web page corresponding to the specified URL is retrieved from the web pages stored in the external storage means 3.

In step S28, it is judged whether or not it is necessary to adjust the display size of the web page. When the informational content of the obtained web page does not have the same display size as at the time when pen-track data was input, it is judged that display size adjustment is necessary, and the procedure advances to step S29.

In step S29, the display size of the web page is adjusted. For example, the display size of the web page is automatically adjusted to the same window size as when the pen-track data was input.

In step S30, the informational content of the web page and the pen-track data are merged, and displayed on the display device 4. At this time, after first displaying the informational content of the web page, it is possible to display the pen-track data as a slow animation in the same order as it was input.

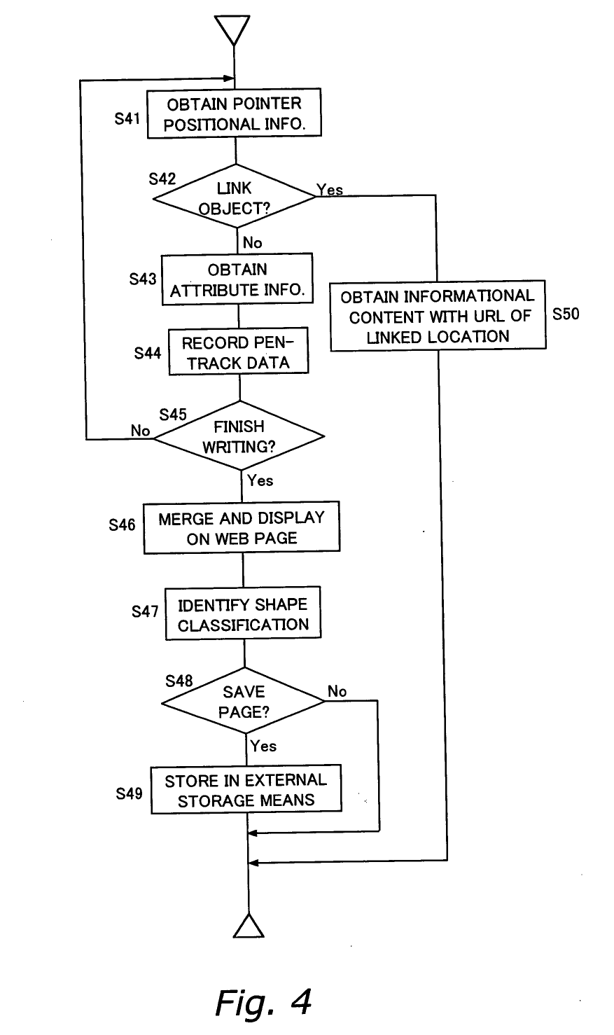

The following is a more detailed description of the processing of pen-track data in step S15 shown in FIG. 2 based on the flowchart in FIG. 4.

In step S41, when handwritten input starts, information about the position of the pointing device 2 in the informational content of the web page is obtained. Conceivable pen-track data input methods include, for example, moving a mouse while holding down the mouse's left button, or moving the tip of an input pen that is in contact with or near to the screen of a tablet. Therefore, the point in time for the start of input is taken as the point in time when the left button of the mouse is clicked, or at the moment when the input pen is brought in contact with or near to the screen of the tablet, and the position of the mouse pointer at this time, or the position of the input pen, is obtained as positional information. Furthermore, a configuration in which the start of handwritten input is specified by predetermined key input from a keyboard is also possible, and it is also possible that this is specified by a button or the like in a menu displayed on the screen.

In step S42, it is judged whether or not the pointing device 2 is on a link object on the web page. When it is judged that a link object is set up on the currently displayed web page, and that the pointing device 2 is indicating the area of this link object, the procedure advances to step S50, or if this is not the case, the procedure advances to step S43.

In step S43, attribute information of the pen-track data is obtained. Attributes information that is preset by the user via the pen-track attribute control means 20 such as the color, the level of transparency, and the line thickness is obtained here.

In step S44, recording of the pen-track data starts based on the obtained positional information and attribute information of the pen-track data. Here, positional information that is input from the pointing device 2, and attribute information that is specified by the pen-track attribute control means 20 are stored in the internal storage means 11 via the handwriting pen-track storage means 16.

In step S45, it is judged whether or not handwritten input is finished. Here it is judged that an instruction has been input to the effect that handwritten input is finished when the left button of the mouse is released from the held-down state, or when the input pen is moved away from the screen of the tablet, and the procedure advances to step 46, or if this is not the case, the procedure advances to step S41 and the recording of pen-track data continues.

In step S46, the pen-track data that is held in the internal storage means 11 is merged with the informational content of the web page currently being displayed on the display device 4 by the browsing means 12, and displayed.

In step S47, the shape classification of the pen-track data that has been input is determined. Pattern recognition is performed on the pen-track data here by the handwriting pen-track identification means 15. The handwriting pen-track identification means 15 determines the shape classification of the pen-track, i.e. it determines whether it is an underline, a closed curve such as a circle, triangle or the like, checkmark, or other shape classifications. A configuration is also possible in which how large the pen-track data is can be judged at the same time, so that size classification of the pen-track data is determined.

In step S48, it is judged whether or not to save the informational content of a web page that has had the input of pen-track data. When there has been an instruction from the user to the effect that the informational content of a web page that has had the input of pen-track data is to be saved, it is judged that the web page is to be saved and the procedure advances to step S49. Furthermore, it may also be set up so that the informational content of the web page is saved when the shape classification of the pen-track data is a preset predetermined shape classification, and in this case the shape classification of the pen-track data is determined and a judgment is made on whether or not to save the data.

In step S49, the informational content of the web page is stored in the external storage means 3. At the same time, pen-track data that is held in the internal storage means 11, and positional information and attribute information that accompany this, as well as other information such as shape classification and size classification are stored in the external storage means 3.

In step 50, it accesses to the URL that is set to the link object on the web page on which the pointing device 2 is positioned for obtaining the informational content there, thus updating the browsing screen on the display device 4.

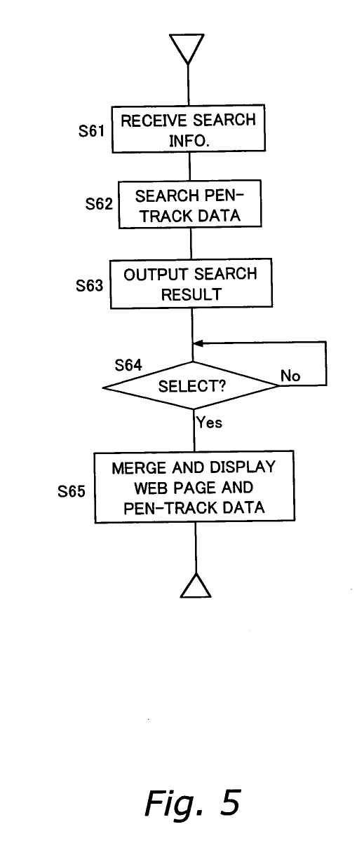

The following is a more detailed description of the pen-track data searching process in step S17 shown in FIG. 2 based on the flowchart in FIG. 5.

In step S61, the search information that is input by the user is received. Here, information that is required to search pen-track data such as attribute data including color, level of transparency, and line thickness, as well as the shape classification and size classification of the pen-track data, is received from the user, and this is used as search information.

In step S62, the pen-track data that is stored in the handwriting pen-track storage means 16 is searched based on the received search information.

In step S63, the results found by searching with the search information from the pen-track data stored by the handwriting pen-track storage means 16 are output. This can be configured so that the informational content of the web page associated with the hit pen-track data are displayed in a reduced arrangement, or so that the URLs of the web pages are displayed in a list.

In step S64, it is judged whether or not a web page from the displayed output of results is selected. When any of the items of informational content of the web pages from the displayed output of results is selected using the pointing device 2 or the like, the procedure advances to step S65.

In step S65, the informational content of the specified web page and the pen-track data associated with this are merged and displayed on the display device 4.

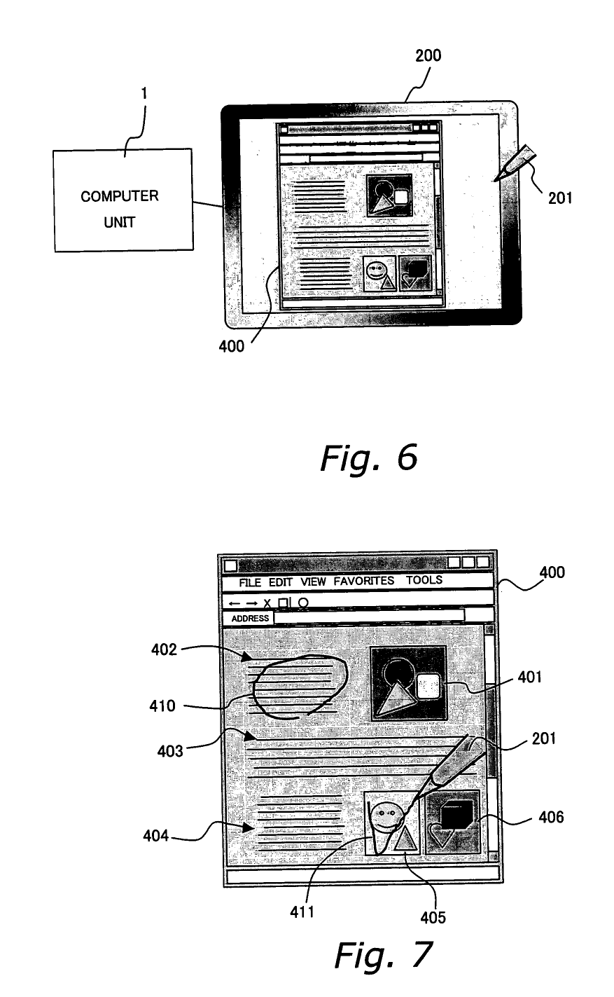

FIGS. 6 and 7 show examples of an input tablet connected to the computer unit 1 and an input pen being used as pointing devices 2.

The input tablet 200 is integrated with a display means such as a liquid crystal display for displaying the informational content of the web pages with the browsing means 12, and a pressure-sensing means for detecting the pen pressure of the input pen 201.

The input tablet 200 is capable of displaying the browsing screen 400 of the web page sent from the browsing means 12 of the computer unit 1, as well as receiving input of pen-track data detected from the pen pressure of the input pen 201.

For example, as shown in FIG. 7, document data 402, 403, and 404, and image data 401, 405, and 406 are arranged in the browsing screen 400, and when there is pen-track data 410 and 411 for these input as handwriting by the input pen 201, these pen-track data 410 and 411 are overlaid and displayed on the browsing screen 400. The color, level of transparency, and thickness of the line(s) of the pen-track data 410 and 411 are determined based on attribute information preset by the user, and are displayed based on the attribute information. It is preferable that default values are selected as the attribute information when the user does not make any particular settings, and in particular, that line(s) are displayed with a certain level of transparency so that items of document data and image data arranged in the browsing screen 400 are easily visible.

The present invention makes it possible for a user to directly handwrite additional information as input to a document displayed by a browsing means, and because previously written-in additional information can be searched and displayed with the document data, an interface similar to that in the case of paper media can be offered, thus making it easy to re-view document data.

While only selected embodiments have been chosen to illustrate the present invention, to those skilled in the art it will be apparent from this disclosure that various changes and modifications can be made herein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A document browser that merges and displays additional information with document data, including text data and/or image data, that can be displayed on a display device, comprising:
an additional information receiving means for receiving input of the additional information;
a browsing means for merging and displaying on the display device the document data with the additional information;
a positional information obtaining means for obtaining the positional information of the additional information in the document data;
a properties information obtaining means for obtaining properties information of the additional information;
an additional information storage means for storing the additional information with the positional information and the properties information;
an additional information searching means for searching the additional information stored in the additional information storage means based on the properties information of the additional information; and
a search results display means for displaying on the display device the search results found by the additional information searching means.

2. The document browser according to claim 1, wherein the document data is an HTML document, an XML document, or other structured document.

3. The document browser according to claim 1, wherein the properties information includes: attribute information included in the additional information such as line color, level of transparency, and line thickness; or other properties data of the additional information such as a shape classification, size, or date and time of input.

4. The document browser according to any of the claims 1, wherein the additional information receiving means comprises a pen tablet, a mouse, or other pointing device.

5. The document browser according to any of the claims 1, wherein the additional information is displayed semi-transparently so that the document data is identifiable when the additional information is merged with the document data.

6. A document browsing method in which additional information is merged and displayed with document data, including text data and/or image data, that can be displayed on a display device, comprising:
a step of displaying the document data on a display device;
a step of receiving an input of additional information with respect to the document data displayed on the display device;
a step of merging and displaying on the display device the document data with the additional information;
a step of obtaining the positional information of the additional information in the document data;
a step of obtaining properties information of the additional information;
a step of storing the additional information with the positional information and the properties information;
a step of searching the additional information stored in the additional information storage means based on the properties information of the additional information; and
a step of displaying on the display device the search results found by the additional information searching means.

7. A recording medium in which a program is recorded for executing a document browsing method on a computer, the document browsing method merging and displaying additional information with document data, including text data and/or image data, that can be displayed on a display device, and comprising:
a step of displaying the document data on a display device;
a step of receiving the additional information input to the document data displayed on the display device;
a step of merging and displaying on the display device the document data with the additional information;
a step of obtaining the positional information of the additional information in the document data;
a step of obtaining properties information of the additional information;
a step of storing the additional information with the positional information and the properties information;
a step of searching the additional information stored in the additional information storage means based on the properties information of the additional information; and
a step of displaying on the display device the search results found by the additional information searching means.
